(19) United States
(12) Patent Application Publication
(10) Pub. No.: US 2010/0063836 A1
(43) Pub. Date: Mar. 11, 2010

(54) Hand Held Prescription Writer Device

(76) Inventor: Rick Ballard, Rochester, MI (US)

Correspondence Address: MICHAEL I KROLL, 115 Eileen Way, Suite 105, SYOSSET, NY, 11791, US

(21) Appl. No.: 12/209,098

(22) Filed: Sep. 11, 2008

(51) Int. Cl. G06Q 50/00

(52) U.S. Cl. 705/2

(57) ABSTRACT

A device for electronically transmitting a medical prescription has a touch screen display, a keyboard, patient, drug and pharmacy databases, a port for inserting of a memory card for updating the databases, software for executing drug interaction, drug compatibility and generic equivalent checks with the databases, software for searching the pharmacy database, and means for wirelessly transmitting a medical prescription to a selected pharmacy.

### BACKGROUND OF THE INVENTION

1. Field of the Invention

The present invention relates generally to prescriptions and, more specifically, to a hand held device for electronic transfer of prescriptions to a pharmacy or the like.

Serious reactions, drug-drug interactions, and medication mistakes involving prescription drugs are often the result of negligent treatment by health care providers. In those instances, doctors, nurses, pharmacists, or other health care providers fail to perform in accordance with the so-called “standard of care.” The hand held device of the present invention improves upon the prescription drug process by electronically transferring of prescription medicine by wireless means to a pharmacy directly from the practitioner.

The prescription writing device is further enhanced by utilizing databases that includes historical and information data of the patient, prescription medicines compatibilities and interactions, medicines generic equivalents and the pharmacies.

The hand held device of the present invention includes a touch screen that when slid open exposes a full keyboard for ease of operation. When applicable, a slot for a card is used to update databases. Another slot provides means for the user to insert a prescription form to allow printing directly from the device. Other ports are also available to provide means for uploading and downloading to other devices and/or systems. The hand held device of the present invention is further enhanced by incorporating means to be used as a cellular telephone, or as a palm for a calendar, contacts, etc.

Software built into the hand held device of the present invention includes means to safe guard transmissions sent to and from the device as well linguistic software to view and translate to and from various languages.

2. Description of the Prior Art

There are other medical prescription systems and devices. Typical of these is U.S. Patent Application Publication No. 2004/0225527 published to Holz on Nov. 11, 2004.

Another was published to Kobylevsky et al. on Mar. 17, 2005 as U.S. Patent Application Publication No. 2005/0060200. Yet another U.S. Pat. No. 6,889,190 was issued to Hegarty on May 3, 2005 and still yet another was issued on Jul. 4, 2006 to Mayaud as U.S. Pat. No. 7,072,840. Another patent was issued to Ahmed on Aug. 21, 2007 as U.S. Pat. No. 7,260,402. Yet another U.S. Pat. No. 7,337,129 was issued to Lowery et al. on Feb. 26, 2008.

Another was published on May 4, 2000 to Sheehan et al. as International Patent Application WO 00/25192. Yet another was published as Korean Publication No. KR20030013694 to Lee. Another was published to Hoy as German Publication No. DE10143577 and still yet another was published to Hill as European Patent Application EP1431902 on Jun. 23, 2004.

### U.S. Patent Application Publication Number 2004/0225527

### Inventor: Siegfried K. Holz

### Published: Nov. 11, 2004

A system for providing and updating a portable patient memory card and for prescription fulfillment. The system includes a modifiable personal memory card (PMC) for the patient which includes the patient's personal information, physician information, pharmacy information, medical history, insurer information and authentification code. A PMC reader/writer presents the stored memory to a personal digital assistant (PDA) during a medical examination by the physician. The physician may then update the stored memory to include new prescriptions and additional medical history. Another PMC reader/writer in the physician's office electronically transfers the updated stored memory to a central host server. The host server receives and stores the updated stored memory and electronically transmits a prescription fulfillment request for new prescriptions to a selected pharmacy and electronically transmits a confirmation back to the office computer when fulfilled. Insurer information may also be electronically transferred from the host server to a designated insurer.

### U.S. Patent Application Publication Number 2005/0060200

### Inventor: Paul Kobylevsky et al.

### Published: Mar. 17, 2005

A prescription refill system having Voice-over-IP (VOIP) capabilities is provided. A central station remote from a pharmacy is provided for receiving phone calls (e.g., PSTN or VOIP calls) relating to prescription information. The central station obtains the prescription information, and automatically dispatches same to a pharmacy for filling. The pharmacy can dial into the central station to receive prescription information, or the information can be periodically faxed, e-mailed, or sent via the internet to the pharmacy. A computer at the pharmacy allows for information to be retrieved from the central station, including voice messages stored at the central station. Calls made to the pharmacy can be forwarded to the central station automatically. A caller calling the central station can be switched to a live operator at the pharmacy for additional assistance.

### U.S. Pat. No. 6,889,190

### Inventor: David D. Hegarty

### Issued: May 3, 2005

This invention relates to a unitary hand held medical prescription transcriber and printing unit. More specifically, a small, portable electronic device is provided which can record words spoken by a physician and from those words generate a printed medical prescription that is delivered directly from the device itself. The unit digitizes words spoken by the user, processes the speech to recognize the words spoken by comparing the acoustic spectral characteristics of the spoken words to the characteristics of a database of known words, formats those words in the form of a prescription, and prints the prescription onto paper using a small integral printer contained in the unit. In an alternate embodiment, the unit may display the prescription on a liquid crystal display screen and the user may edit the prescription before printing a hard copy. The unit assists in accurate dispensing of medicines by providing a legible prescription printout, while at the same time being neither time consuming nor difficult to operate.

### U.S. Pat. No. 7,072,840

### Inventor: Christian Mayaud

### Issued: Jul. 4, 2006

A prescription creation software system implemented on a computer is provided. The prescription creation software system includes a prescription creation screen display to allow the data capture of information including, patient-identifying data, prescribed drug identification data and drug quantification data. The prescription creation software system additionally provides a prescriber with drug formulary information identifying at least one drug as a patient's drug formulary preference, prior to completion of the prescription.

### U.S. Pat. No. 7,260,492

### Inventor: Omar Ahmad

### Issued: Aug. 21, 2007

A control system for a failure mode testing system is described. The control system employs at least one control algorithm that enables the testing system to be operated at optimal pressure and frequency levels in order to generate a desired system response, such as a desired energy level and desired slope of the fast Fourier transform of the system response. Also described are a pressure dither system and a frequency ringing system for enhancing the operation of the actuator cylinders of the failure mode testing system. All three of the systems can be incorporated, either singularly or in combination, into a computer software program that can be employed to operate and control the failure mode testing system.

### U.S. Pat. No. 7,337,129

### Inventor: Ethan Lowery

### Issued: Feb. 26, 2008

Methods and apparatuses for on-line prescription ordering are described. A prescription order is placed via a World Wide Web site and stored in a database. A server device periodically searches the database for new prescription orders. New prescription orders are routed to a distribution center for processing. The appropriate medical data (e.g., age, medical condition) is also routed to the distribution center for use in filling the prescription. Insurance information is collected and processed, if necessary. In one embodiment, in certain situations, a “pre-fill” order is sent to the distribution center to cause the distribution center to determine the actual medication to be dispensed, the cost covered by the insurance and other prescription processing to occur. In response to a user making financial arrangements (e.g., providing a credit card number) to cover any costs not covered by the insurance the prescription is filled and is shipped to the appropriate individual.

### International Publication Application Number WO 00/25192

### Inventor: David M. Sheehan et al.

### Issued: May 4, 2000

A prescription-controlled diagnostic data collection system for collecting, storing and receiving medical diagnostic data. A remote medical diagnostic device is configured to collect and transmit diagnostic data. A health service provider prepares a prescription that authorizes the remote diagnostic device to collect and/or transmit diagnostic data. The prescription includes an identifier unique to the device. A central server receives and stores the prescription from the prescribing party and stores status and data information associated with the prescription. A base unit transfers data and authorization information between the remote medical diagnostic device and the server. The remote diagnostic device is operable by a patient independently of the server and the health care provider to collect the diagnostic data, and is operable to transmit the diagnostic data to the server when appropriate authorizations have been received by the base unit from the server. A prescription-controlled diagnostic data collection system for collecting, storing and receiving medical diagnostic data. A remote medical diagnostic device is configured to collect and transmit diagnostic data. A health service provider prepares a prescription that authorizes the remote diagnostic device to collect and/or transmit diagnostic data.

### Korean Patent Application Number KR20030013694

### Inventor: Hun Se Lee

### Published: Feb. 15, 2003

PURPOSE: A herb medicine prescription transmitting process is provided to prepare a herb medicine and deliver the herb medicine to a user in a herb medicine pharmacy by deciding a prescription adapted to a patient's condition in an off-line herbalist hospital, and transmitting the prescription to a pharmacy using the Internet in a remote place after deciding the prescription in a DB in a web server on the Internet. CONSTITUTION: A prescription being used in an oriental medicine is registered in a web server on the Internet as a prescription DB. Thus, a user searches a necessary prescription in the prescription DB and performs a prescription. That is, a prescription necessary for a medical treatment by an Oriental medicine is registered in the web server. A prescription may be appended, deleted, or added. The user registers the finally decided prescription as a bookmark.

### German Patent Number DE10143577

### Inventor: Bjoern Hoy et al.

### Issued: Apr. 24, 2003

Method in which an authentication document or prescription is scanned in with a de-centralized device, the document is digitized and transmitted to a central computer, the digitized document is transferred to a central computer evaluation system in which it is evaluated using completeness, plausibility and validity testing. If the evaluation is successful, delivery of the prescribed product is triggered. The invention also relates to a corresponding system for inputting a prescription electronically, transfer to a central system and final testing of its authenticity, generation of a receipt, and provision of the prescription to the authenticated person.

### European Patent Application Number EP1431902

### Inventor: Kenneth A. Hill, Sr.

### Published: Jun. 23, 2004

A method and system for prescription management is described. At least one prescription is received at a pharmacy and an order associated with at least one of the prescriptions is generated. A shipping location associated with the order is determined and the order is communicated to a central fill facility for filling the prescriptions associated with the order. A cost associated with the order is received from the central fill facility. The cost includes a shipping cost and an order cost. Payment is settled for the order based on the cost. In one embodiment, the prescription is filled with the prescribed drug at the central fill or a remote third-party facility for delivery of the drug to a location designated by the patient on behalf of, but independent of, the designated pharmacy.

While these prescription writing system and devices may be suitable for the purposes for which they were designed, they would not be as suitable for the purposes of the present invention, as hereinafter described.

### SUMMARY OF THE PRESENT INVENTION

A primary object of the present invention is to provide portable wireless handheld device whereby the prescriber can enter patient and prescription information that will be wirelessly transmitted to a pharmacist.

Another object of the present invention is to provide portable wireless handheld device that includes a patient database of historical medical records.

Yet another object of the present invention is to provide a portable wireless handheld device that allows the practitioner to modify or update the patient database of historical medical records.

Another object of the present invention is to provide a portable wireless handheld device that includes a prescription medicine database that comprises brand names, generic names, national code numbers, therapeutic uses, and drug confliction warnings.

Still yet another object of the present invention is to provide a portable wireless handheld device that includes a pharmacist database that comprises pharmacy names and contact information.

Another object of the present invention is to provide a prescription writer that reduces the chance of the patient receiving the wrong medicine.

Yet another object of the present invention is to provide a prescription writer that reduces the chance of the patient receiving conflicting medicines.

Still yet another object of the present invention is to provide a prescription writer that improves efficiency in the prescription process.

Additional objects of the present invention will appear as the description proceeds.

The present invention overcomes the shortcomings of the prior art by providing a portable wireless handheld device whereby the prescriber can enter patient and prescription information that will be wirelessly transmitted to a pharmacist that in turn reduces the chance of error while improving efficiency.

The foregoing and other objectives and advantages will appear from the description to follow. In the description, reference is made to the accompanying drawings, which forms a part hereof, and in which is shown, by way of illustration, specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawings in which:

FIG. 1 is an illustrative view of prior art.

FIG. 2 is an illustrative view of the present invention in use.

FIG. 3 is an illustrative view of the present invention in use.

FIG. 4 is an illustrative view of the present invention in use.

FIG. 5 is a perspective view of the present invention in the open position.

FIG. 6 is a perspective view of the present invention in the closed position.

FIG. 7 is a frontal view of the present invention.

FIG. 8 is a block diagram of the present invention's prescription writer.

FIG. 9 is a block diagram of the present invention's prescription writer patient database.

FIG. 10 is a block diagram of the present invention's prescription writer drug database.

FIG. 11 is a block diagram of the present invention's prescription writer pharmacy database.

FIG. 12 is a block diagram of the present invention's prescription writer.

### DESCRIPTION OF THE REFERENCED NUMERALS

Turning now descriptively to the drawings, in which similar reference characters denote similar elements throughout the several views, the figures illustrate the Hand Held Prescription Writer Device of the present invention. With regard to the reference numerals used, the following numbering is used throughout the various drawing figures.
10 Hand Held Prescription Writer Device of the present invention
12 physician
14 patient
16 pharmacist
18 centralized computer
20 signal
22 pharmacy database
24 slidable touch screen display
26 calendar
28 contacts
30 prior art
32 wrong prescription
34 calculator
36 setup
38 tasks
40 help
42 keyboard
44 communication keys
46 slide channel
48 speaker
50 receiver
52 printer
54 paper slot
56 USB port
58 memory card port
60 transmit
62 print
64 edit
66 new
68 save
70 prescription form
72 informational services
73 linguistic software
75 encryption software
74 patient database
76 drug database
78 pharmacy database
80 demographics
82 medical history
84 medical encounters
86 orders
88 progress reports
90 test results
92 other information
94 brand name
96 generic name
98 national drug number
100 therapeutic uses
102 pharmacy names
104 contact information
106 recognized insurance providers
108 consumer report

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

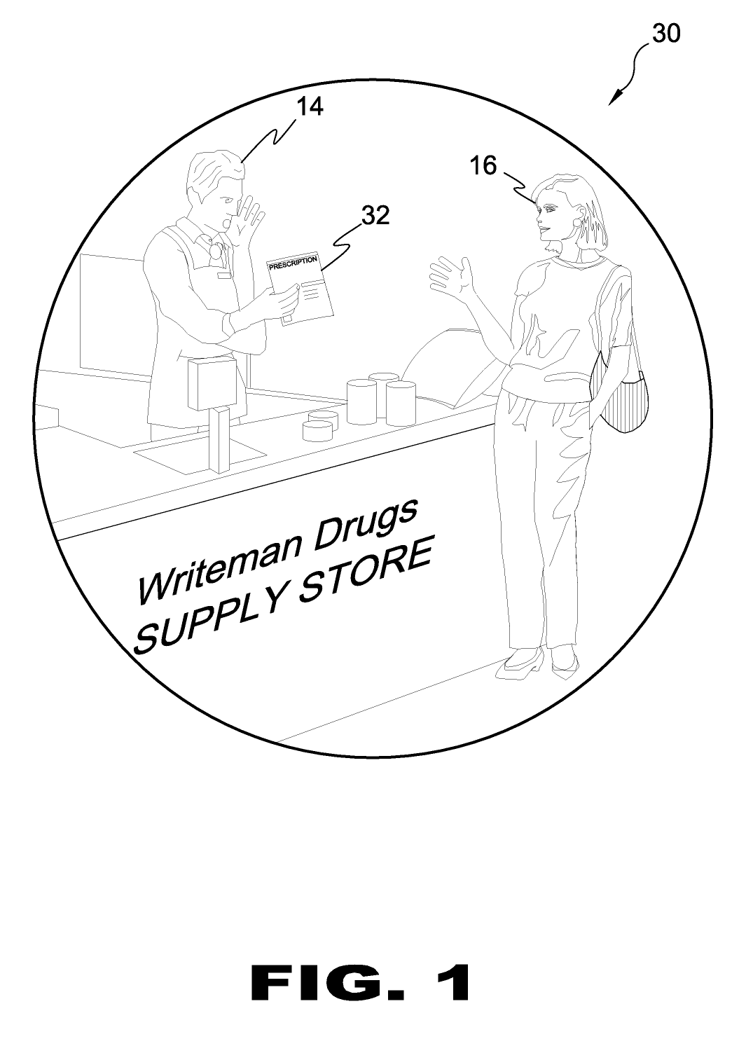

FIG. 1 is an illustrative view of prior art 30. Depicted is a patient 14 receiving the wrong medicine 32 from a pharmacist 16 due to human error. Serious reactions, drug-to-drug interactions, and medication mistakes involving prescription drugs are often the result of negligent treatment by health care providers. In those instances, doctors, nurses, pharmacists 16, or other health care providers fail to perform in accordance with the so-called “standard of care.”

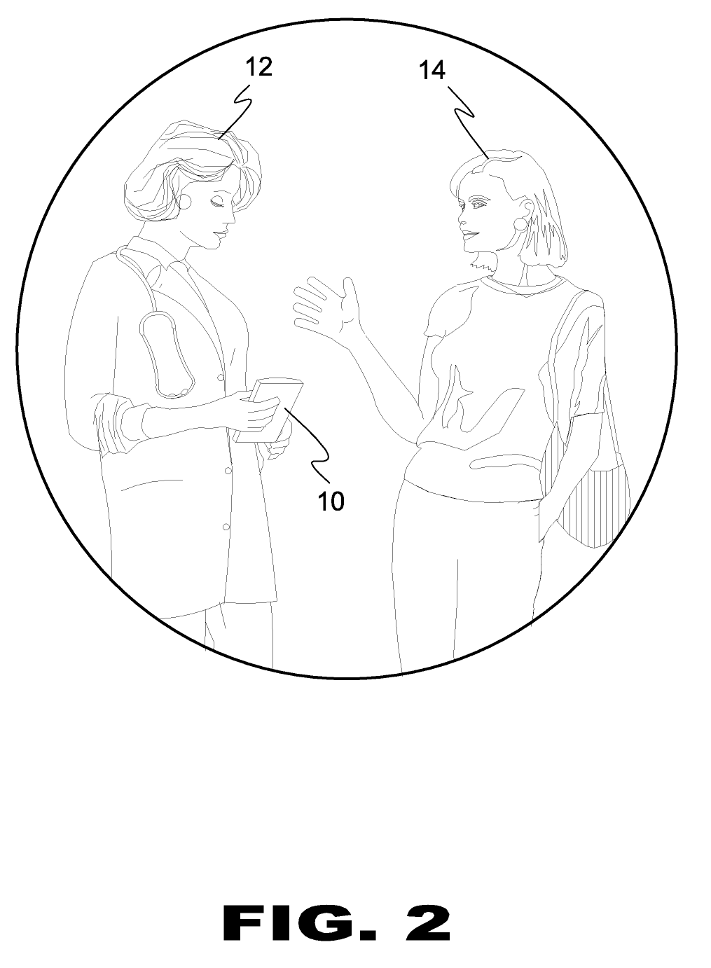

FIG. 2 is an illustrative view of the present invention 10 in use. Depicted is the hand held prescription writer device 10 in use. Shown is a physician 12 entering prescription information on the hand held device 10 for a patient 14. The hand held device 10 provides means to electronically submit a medical prescription from the practitioner 12 directly to the pharmacist 16. Databases contained within the device 10 provide safeguards and reduce the chance of error of a person receiving the wrong medicine. The hand held device 10 also is multifunctional and can be utilized as a cellular telephone, messaging system, or palm, i.e. calendar, contacts, etc. Additionally, the hand held device 10 includes software to view and translate to and from various languages.

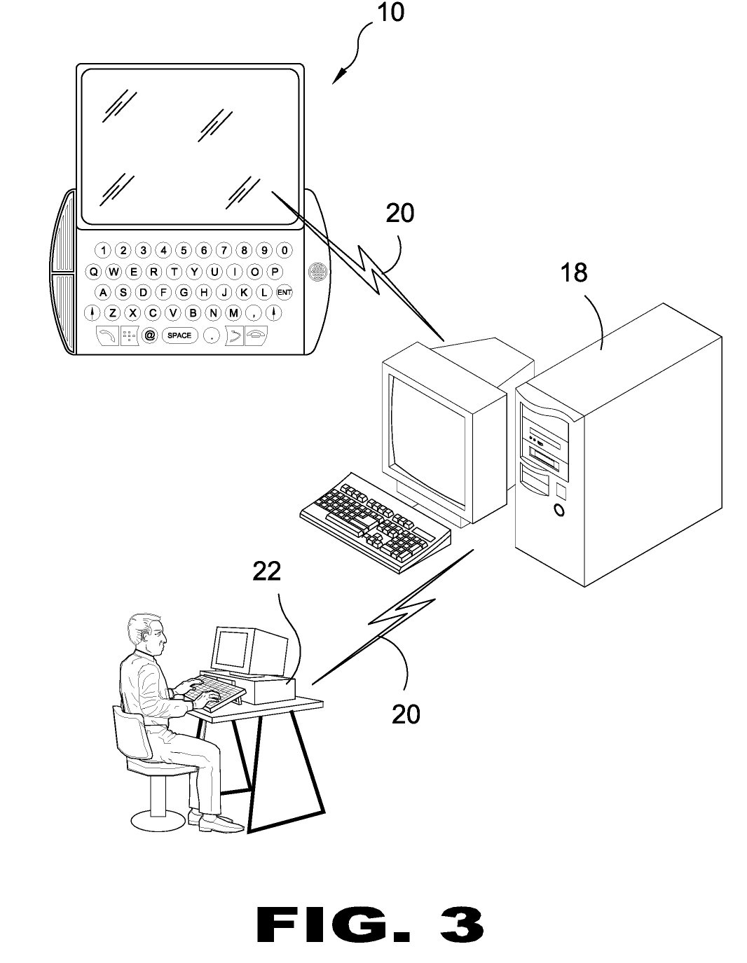

FIG. 3 is an illustrative view of the present invention 10 in use. Shown is the hand held device 10 wirelessly transmitting a signal 20 to a centralized computer 18 within the practitioner's office that in turn transmits a signal 20 regarding the prescription to the pharmacy database 22. The hand held device 10 includes means to send information to other systems such as a centralized computer 18 for record keeping, backup purposes and provide safe guard tracking and analysis. The hand held device 18 also includes a speaker and receiver for phone use.

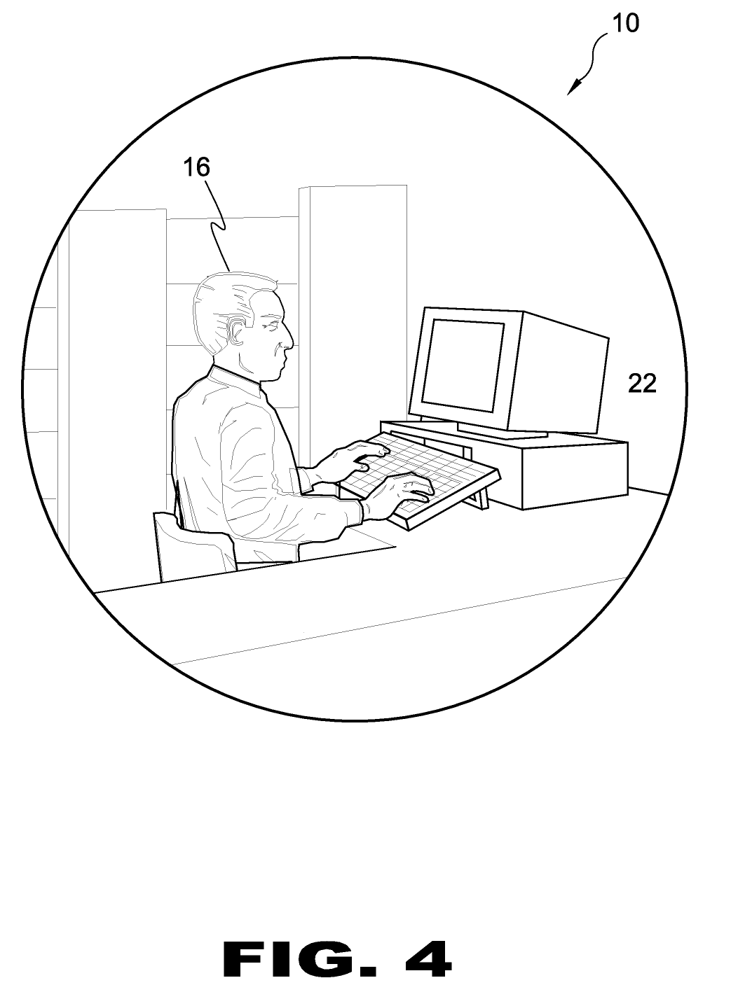

FIG. 4 is an illustrative view of the present invention 10 in use. Shown is the pharmacist 16 receiving prescription information sent from the prescription writing device 10 to the pharmacy database 22. In addition to reducing error, the prescription writing device 10 provides means for improved efficiency.

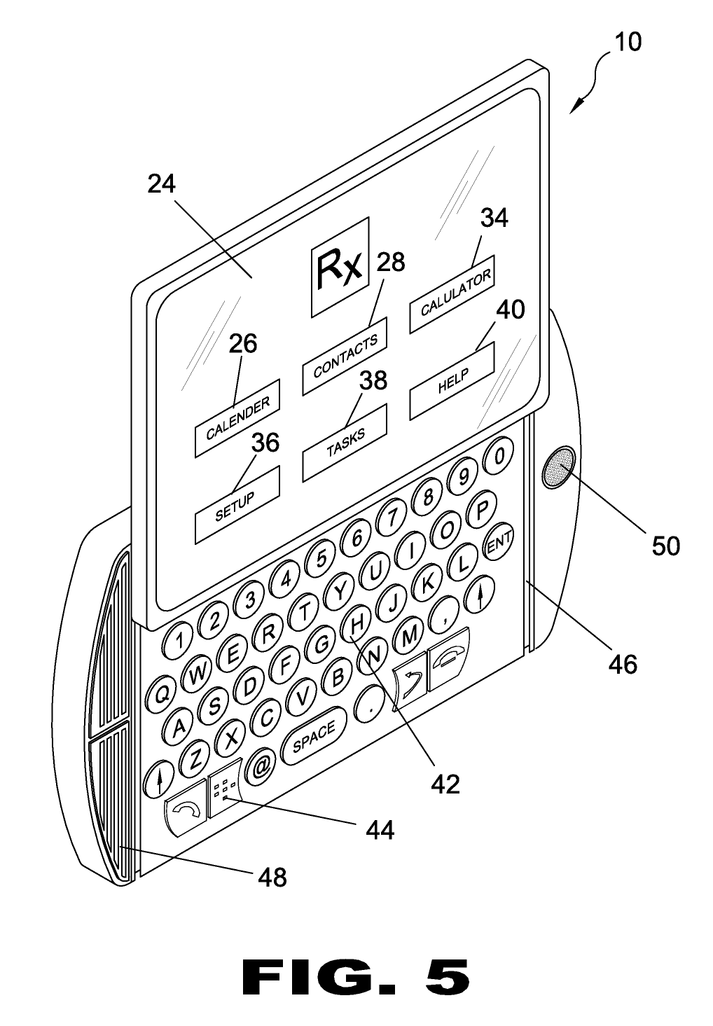

FIG. 5 is a perspective view of the present invention 10 in the open position. Shown are the various functions of the present invention 10 including a slidable touch screen display 24 providing access to calendar 26, contacts 28, 34, setup 36, tasks 38 and help 40 functions. The display screen 24 slides within channels 46 to reveal a keyboard 42. A speaker 48, receiver 50 and communication keys 44 are provided to enable use as a cell phone.

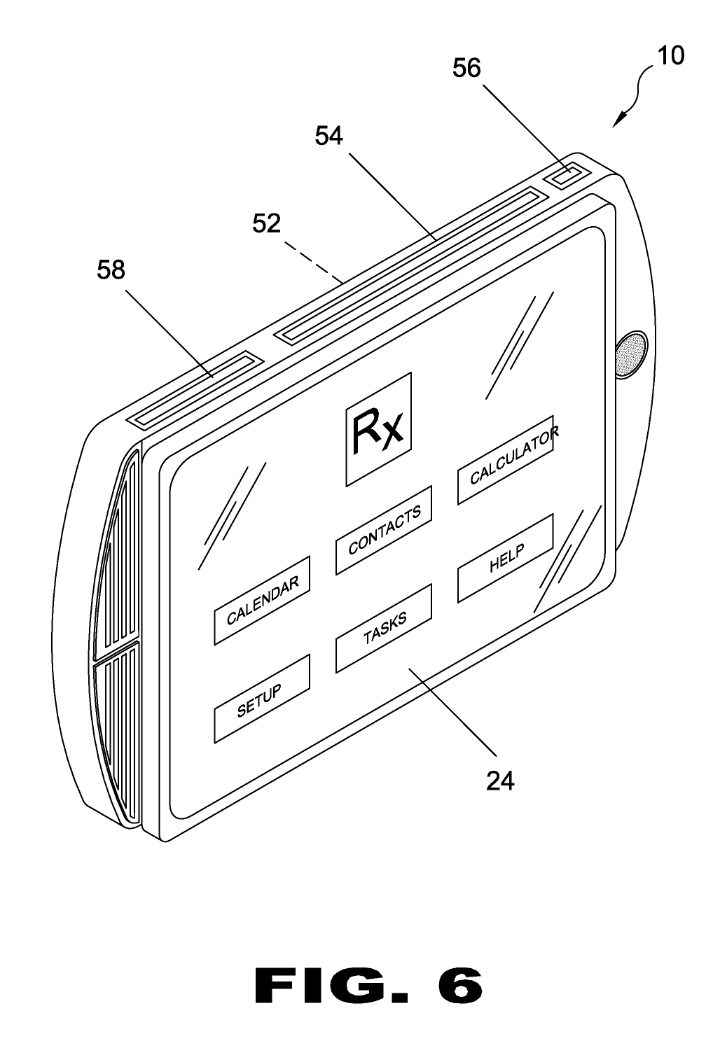

FIG. 6 is a perspective view of the present invention 10 in the closed position. In the closed position, the touch screen 24 encloses the keyboard. The hand held device 10 is equipped with a printer 52 and paper slot 54 to insert Rx paper for printing of the prescription. Additionally, the hand held device 10 is equipped with a memory card port 58 that is used to upload various databases. Furthermore, the hand held device 10 is equipped with a USB port 56 for interconnection with other devices and/or services.

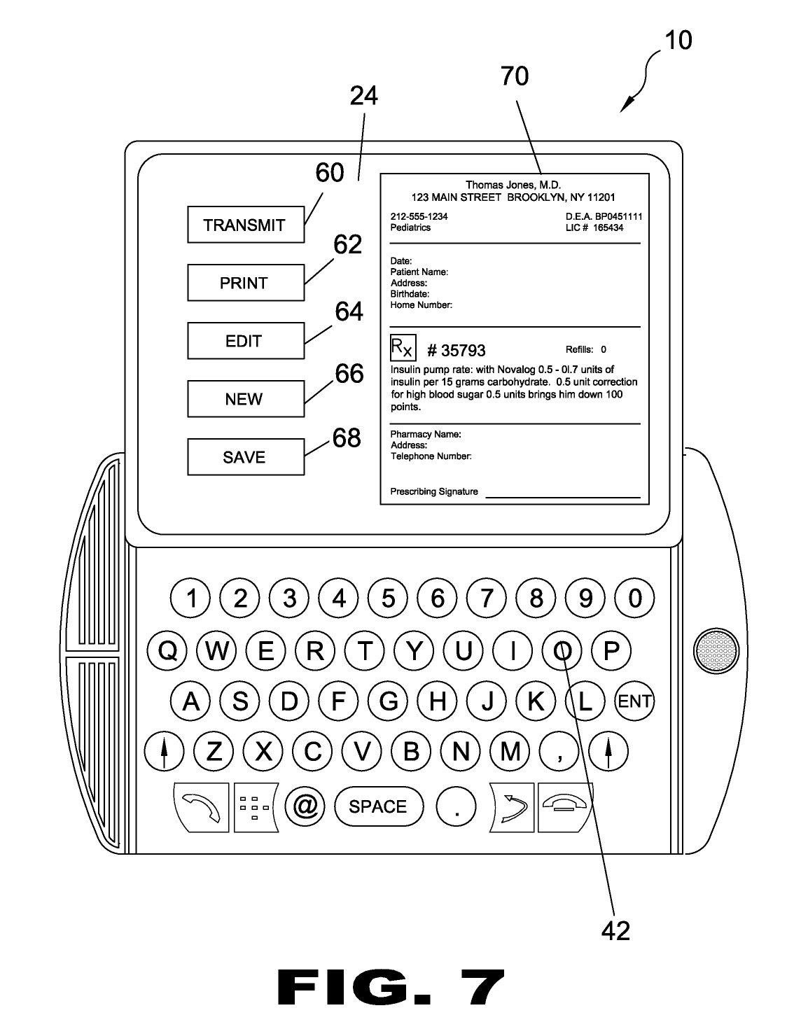

FIG. 7 is a frontal view of the present invention 10. Shown is the touch screen 24 having transmit 60, print 62, edit 64, new 66 and save 68 functions along with a prescription form 70 that is filled out through use of the keyboard 42.

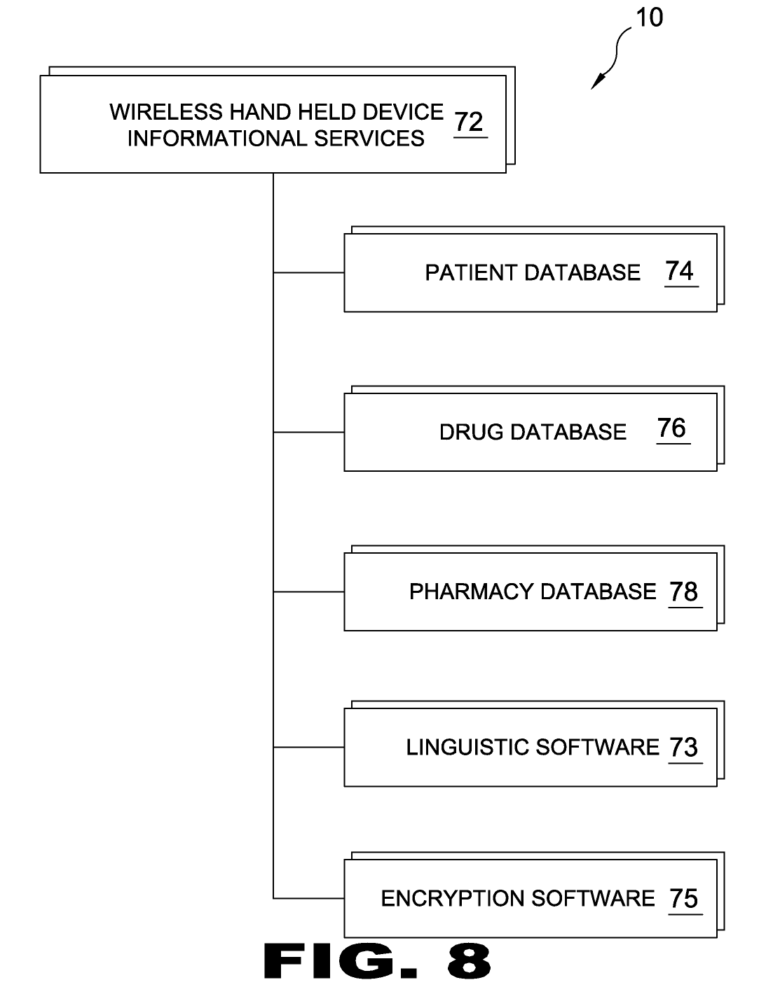

FIG. 8 is a block diagram of the present invention's prescription writer. The hand held device is utilized to transmit medical prescriptions electronically from the prescriber to a pharmacy. The hand held device includes informational services 72 for accessing databases regarding, patient information 74, drug data 76, pharmacy information 78, encryption software 75 and linguistic software 73 for translating data to and from various languages.

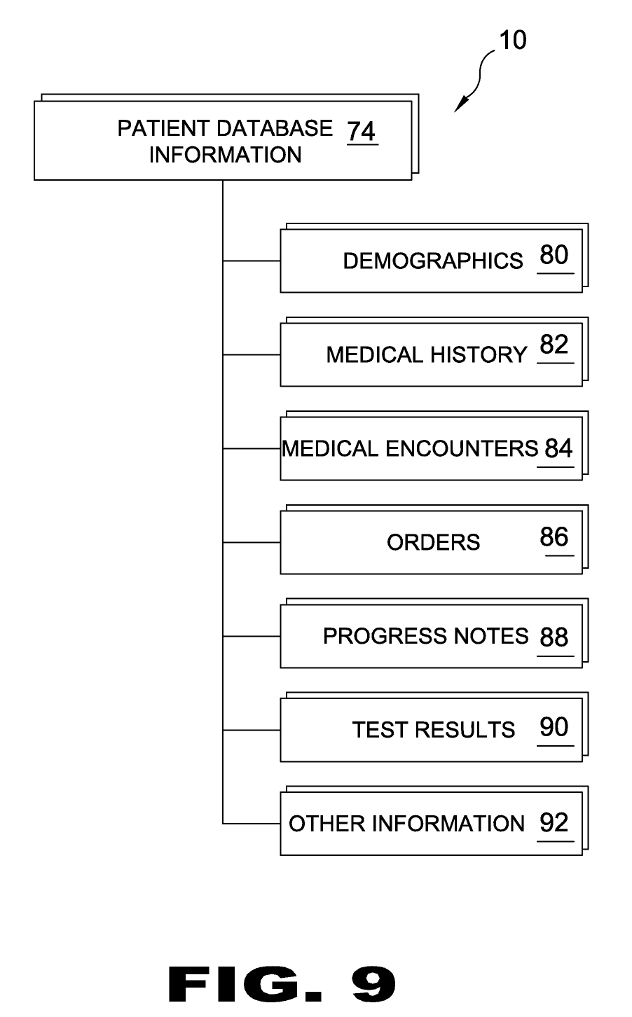

FIG. 9 is a block diagram of the present invention's 10 prescription writer patient database 74 and some of the available data stored therein including demographics 80, medical history 82, medical encounters 84, orders 86, progress notes 88, test results 90 and other information 92. The patient database 74 allows the practitioner to read, modify or update patient medical history.

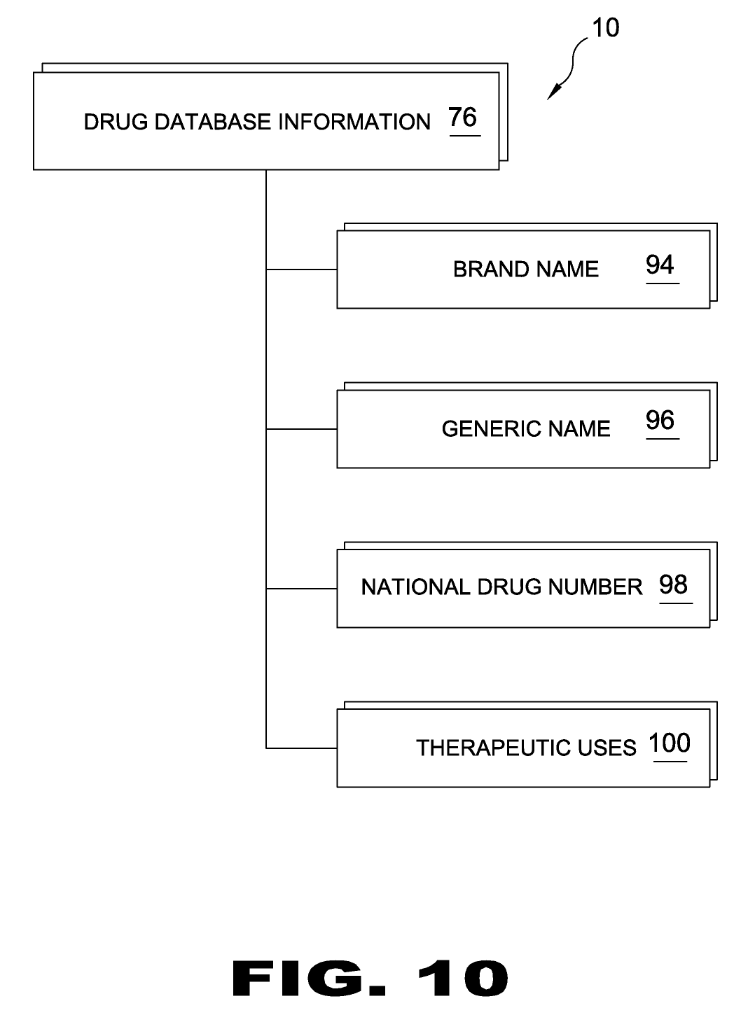

FIG. 10 is a block diagram of the present invention's 10 prescription writer drug database 76 and some of the available data stored therein including the brand name 94, generic name 96, national drug number 98 and therapeutic uses 100.

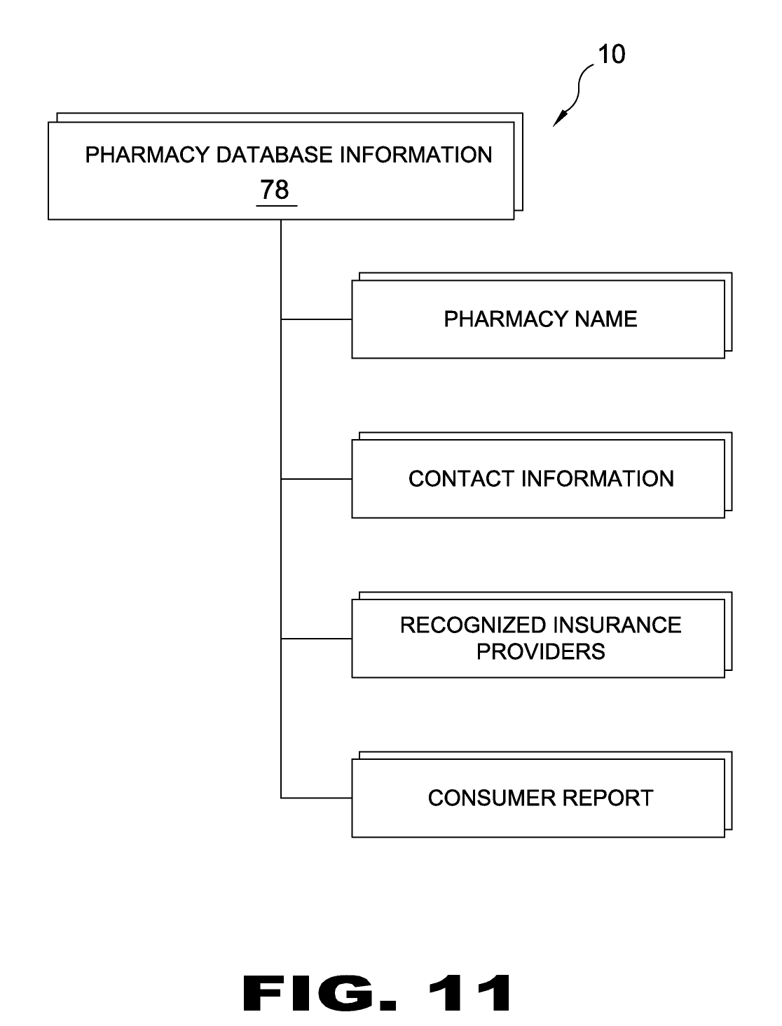

FIG. 11 is a block diagram of the present invention's 10 prescription writer pharmacy database 78 including pharmacy names 102, contact information 104, recognized insurance providers 106 and consumer report 108.

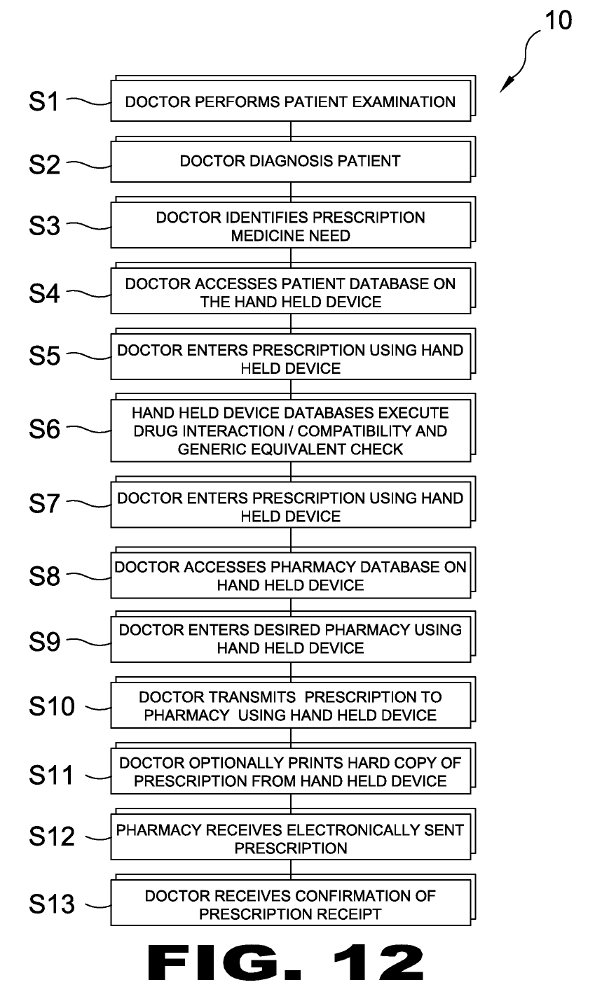

FIG. 12 is a block diagram of the present invention's prescription writer 10. Depicted is a flow chart of the process to transmit a prescription utilizing the wireless hand held device 10.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A hand held device for transmitting medical prescriptions electronically from a prescriber to a pharmacy comprising:
a) display means;
b) input means;
c) a patient database;
d) a drug database;
e) a pharmacy database;
f) means for updating said patient, drug and pharmacy databases;
g) software means for executing drug interaction, drug compatibility and generic equivalent checks with said patient and drug databases;
h) software means for executing a pharmacy search for a selected pharmacy with said pharmacy database; and
i) means for wirelessly transmitting a medical prescription to a selected pharmacy.

2. A hand held device for transmitting medical prescriptions electronically from a prescriber to a pharmacy according to claim 1, wherein said display means is a screen.

3. A hand held device for transmitting medical prescriptions electronically from a prescriber to a pharmacy according to claim 2, wherein said screen is an LCD.

4. A hand held device for transmitting medical prescriptions electronically from a prescriber to a pharmacy according to claim 3, wherein said input means is a keyboard.

5. A hand held device for transmitting medical prescriptions electronically from a prescriber to a pharmacy according to claim 4, wherein said screen is a touch screen display.

6. A hand held device for transmitting medical prescriptions electronically from a prescriber to a pharmacy according to claim 5, wherein said patient database contains patient historical medical records and patient drug compatibility information.

7. A hand held device for transmitting medical prescriptions electronically from a prescriber to a pharmacy according to claim 6, wherein said drug database contains brand name, generic name, national code number, therapeutic use and drug conflict information for prescription medicines.

8. A hand held device for transmitting medical prescriptions electronically from a prescriber to a pharmacy according to claim 7, wherein said pharmacy database contains pharmacy names, locations and contact information.

9. A hand held device for transmitting medical prescriptions electronically from a prescriber to a pharmacy according to claim 8, wherein said means for updating said patient, drug and pharmacy databases is a port for insertion of a memory card.

10. A hand held device for transmitting medical prescriptions electronically from a prescriber to a pharmacy according to claim 9, further comprising printing means for printing a medical prescription.

11. A hand held device for transmitting medical prescriptions electronically from a prescriber to a pharmacy according to claim 10, wherein said printing means comprises a slot for receiving a paper prescription form.

12. A hand held device for transmitting medical prescriptions electronically from a prescriber to a pharmacy according to claim 9, further comprising means for uploading and downloading to other electronic devices.

13. A hand held device for transmitting medical prescriptions electronically from a prescriber to a pharmacy according to claim 12, wherein said means for uploading and downloading to other electronic devices comprises an electronic port.

14. A hand held device for transmitting medical prescriptions electronically from a prescriber to a pharmacy according to claim 13, wherein said electronic port is a USB port.

15. A hand held device for transmitting medical prescriptions electronically from a prescriber to a pharmacy according to claim 9, further comprising software means for safeguarding wireless transmissions.

16. A hand held device for transmitting medical prescriptions electronically from a prescriber to a pharmacy according to claim 15, wherein said software means for safeguarding wireless transmissions comprises encryption software.

17. A hand held device for transmitting medical prescriptions electronically from a prescriber to a pharmacy according to claim 9, further comprising a cellular telephone.

18. A hand held device for transmitting medical prescriptions electronically from a prescriber to a pharmacy according to claim 9, further comprising a messaging means.

19. A hand held device for transmitting medical prescriptions electronically from a prescriber to a pharmacy according to claim 9, further comprising calendar software.

20. A hand held device for transmitting medical prescriptions electronically from a prescriber to a pharmacy according to claim 9, further comprising linguistic software to view and translate to and from a plurality of languages.

21. A hand held device for transmitting medical prescriptions electronically from a prescriber to a pharmacy according to claim 9, wherein, in a closed position, said touch screen encloses said keyboard, and in an open position said keyboard is exposed.

22. A hand held device for transmitting medical prescriptions electronically from a prescriber to a pharmacy comprising:
a) a touch screen display;
b) a keyboard movably connected to said touch screen display such that, in a closed position, said touch screen encloses said keyboard, and in an open position said keyboard is exposed;
c) a patient database containing patient historical medical records and patient drug compatibility information;
d) a drug database containing brand name, generic name, national code number, therapeutic use and drug conflict information for prescription medicines;
e) a pharmacy database containing pharmacy names, locations and contact information;
f) a port for insertion of a memory card for updating said patient, drug and pharmacy databases;
g) software means for executing drug interaction, drug compatibility and generic equivalent checks with said patient and drug databases;
h) software means for executing a pharmacy search for a selected pharmacy with said pharmacy database;
i) printing means for printing a medical prescription;
j) a slot for receiving a paper prescription form into said printing means;
k) a port for connecting to other electronic devices;
l) means for wirelessly transmitting a medical prescription to a selected pharmacy; and
m) software means for safeguarding wireless transmissions.

23. A hand held device for transmitting medical prescriptions electronically from a prescriber to a pharmacy according to claim 22, further comprising a cellular telephone.

24. A hand held device for transmitting medical prescriptions electronically from a prescriber to a pharmacy according to claim 23, further comprising linguistic software to view and translate to and from a plurality of languages.

25. A method of electronically transferring a medical prescription after identifying a patient's prescription medicine needs comprising the steps:
a) providing a hand held device display means having a touch screen display; a keyboard; a patient database containing patient historical medical records and patient drug compatibility information; a drug database containing brand name, generic name, national code number, therapeutic use and drug conflict information for prescription medicines; a pharmacy database containing pharmacy names, locations and contact information; a port for insertion of a memory card for updating said patient, drug and pharmacy databases; software for executing drug interaction, drug compatibility and generic equivalent checks with said patient and drug databases; software means for executing a pharmacy search for a selected pharmacy with said pharmacy database; and means for wirelessly transmitting a medical prescription to a selected pharmacy;
b) accessing said patient database for records of a selected patient;
c) entering the patient's identified prescription medicine into said hand held device;
d) executing drug interaction, drug compatibility and generic equivalent checks with said patient and drug databases;
e) accessing said pharmacy database;
f) selecting a pharmacy from said pharmacy database; and
g) transmitting a prescription for the patient's prescription medicine to said selected pharmacy with said wireless transmission means.

26. A method of electronically transferring a medical prescription according to claim 25, further comprising the step of printing a copy of a medical prescription with printing means in said hand held device.

27. A method of electronically transferring a medical prescription according to claim 26, further comprising the step of receiving a confirmation of receipt of the prescription from said selected pharmacy.

28. A method of electronically transferring a medical prescription according to claim 25, further comprising the step of encrypting wireless transmissions.

29. A method of electronically transferring a medical prescription according to claim 25, further comprising the step of connecting said hand held device to an electronic device through a USB port.

30. A method of electronically transferring a medical prescription according to claim 25, further comprising the step of updating said patient, drug or pharmacy database.

31. A method of electronically transferring a medical prescription according to claim 25, further comprising the step of translating to and from a plurality of languages with linguistic software in said hand held device.
